(19) United States
(12) Patent Application Publication
(10) Pub. No.: US 2026/0353183 A1
(43) Pub. Date: Nov. 5, 2026

(54) FEEDBACK ABSENCE AND TYPE INDICATION

(71) Applicant: QUALCOMM Incorporated, San Diego, CA (US)

(72) Inventors: Sanket Sanjay KALAMKAR, San Diego, CA (US); Alfred ASTERJADHI, San Diego, CA (US); Abhishek Pramod PATIL, San Diego, CA (US); George CHERIAN, San Diego, CA (US); Sherief HELWA, San Diego, CA (US); Gaurang NAIK, San Diego, CA (US); Giovanni CHISCI, San Diego, CA (US); Sai Yiu Duncan HO, San Diego, CA (US)

(21) Appl. No.: 19/655,279

(22) Filed: Apr. 22, 2026

Related U.S. Application Data
(60) Provisional application No. 63/799,089, filed on May 2, 2025.

(51) Int. Cl. H04W 28/06

(52) U.S. Cl. CPC H04W 28/06

(57) ABSTRACT

Certain aspects of the present disclosure provide techniques for indicating the presence, absence and/or type of feedback carried in a frame. An example method, performable at a wireless node, generally includes generating a first frame that includes a first field, where a value in the first field indicates whether feedback is included in the first frame, and transmitting the first frame including the first field.

### CROSS-REFERENCE TO RELATED APPLICATION(S)

This application claims priority to and benefit of U.S. Provisional Patent Application No. 63/799,089, filed May 2, 2025, which is hereby incorporated by reference herein.

### TECHNICAL FIELD

This disclosure relates generally to wireless communication, and more specifically, to mechanisms for indicating the presence, absence and/or type of feedback carried in a frame.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a wireless node. The method includes generating a first frame that includes a first field, where a value in the first field conveys information indicative of whether feedback is included in the first frame. and transmitting the first frame including the first field.

Another innovative aspect of the subject matter described in this disclosure can be implemented in a method for wireless communication at a wireless node. The method includes receiving a first frame that includes a first field, where a value in the first field conveys information indicative of whether feedback is included in the first frame. and processing the first frame in accordance with the information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a timing diagram for an example frame exchange.

FIG. 5 shows an example call flow diagram for indicating the presence, absence and/or type of feedback carried in a frame, in accordance with aspects of the present disclosure.

FIG. 6 shows an example frame format, in accordance with aspects of the present disclosure.

FIG. 7 shows a flowchart illustrating example process performable by a wireless device or wireless node.

FIG. 8 shows a flowchart illustrating example process performable by a wireless device or wireless node.

FIG. 9 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels, where Nₛ≤min{N_{T}, N_{R}}. Each of the N_{S} independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Many challenges are present in such systems. For example, the AP may transmit signals using different standards. A receiver STA may be able to detect a transmission mode of the signal based on information included in a preamble of the transmission packet.

A downlink multi-user MIMO (MU-MIMO) system based on Spatial Division Multiple Access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

In a distributed MU-MIMO system, multiple APs may simultaneously serve a plurality of spatially separated STAs by coordinating beamforming by the antennas of the multiple APs. For example, in systems utilizing such coordinated beamforming (CoBF), multiple APs may coordinate transmissions to each STA in an effort to mitigate interference to each other's STAs.

In CoBF, an AP of one basic service set (BSS) may obtain channel state information (CSI) from non-AP STAs of an overlapping BSS (OBSS) in order to mitigate interference (e.g., by forming nulls) to the STA(s). This may involve cross-BSS sounding and CSI feedback from non-AP STA(s) to OBSS AP(s). Each AP may also obtain CSI from its own BSS non-AP STA(s) for forming beams to the STA(s).

In this manner, CoBF may be considered a coordinated AP scheme that aims at simultaneously using the medium in two BSSs to maximize the system throughput. CoBF attempts to exploit the participating APs'hardware capabilities (e.g., larger antenna arrays) to actively null their signals at OBSSs'clients using transmission beamforming to limit OBSS interference.

Advanced wireless systems, such as those utilizing coordinated communication schemes (e.g., CoBF, coordinated TDMA (C-TDMA), dynamic unavailability operation (DUO)), often rely on various forms of feedback information. Such feedback information may be carried in certain types of frames, such as initial control frames (ICFs), initial control response (ICR) frames, and/or control response frames (CRFs). Such feedback information may include CoBF information, coordinated time division multiple access (C-TDMA) information, or some other type of feedback information.

In some cases, however, a frame designed to convey feedback may be ready to be transmitted when there is no feedback available. Uncertainty may exist as to whether the frame should still be transmitted in such cases (e.g., another device may be expecting the frame). For example, a receiving device may not know how to interpret the frame that lacks the expected feedback, whether the frame lacks a feedback information field designed to carry the expected feedback or the feedback information field is populated despite the lack of meaningful feedback. Either case may lead to an inefficient use of processing resources and increased power consumption.

Aspects of the present disclosure, however, provide various signaling mechanisms for indicating whether a frame carries feedback (and/or what type of feedback is carried in the frame). For example, in some aspects, a device (e.g., a wireless station (STA)) may generate a frame, such as a trigger frame, that includes information indicating whether the frame includes feedback. As one specific example, in some aspects, the STA may generate a frame that includes a field that is set to a first value to indicate that the frame includes feedback or may generate a frame with the field set to a different value that indicates the frame does not include feedback. In some cases, when the field indicates that the frame includes feedback, one or more values of the field may also indicate a type of the feedback.

By providing mechanisms for signaling whether a frame includes feedback, aspects of the present disclosure may help improve performance by allowing the frame to be generated before knowing whether it will include feedback. For example, other portions of the frame can be generated and a feedback type field may be updated (prior to transmission) once it is known whether or not the frame will include feedback. This approach may reduce latency and allow the frame to be transmitted sooner. Further, by signaling whether a frame includes feedback, the uncertainty noted above may be removed, which may help make more efficient use of processing resources and reduce power consumption.

### Example Wireless Communication Network

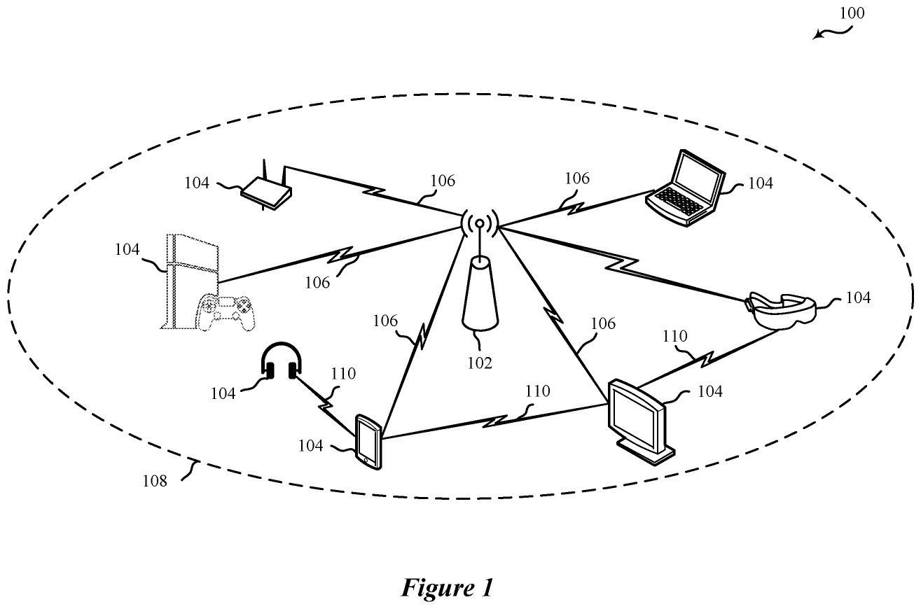

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network (e.g., WLAN) 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz 52.6 GHz), FR3 (7.125 GHz- 24.25 GHz), FR4a or FR4-1 (52.6 GHz- 71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

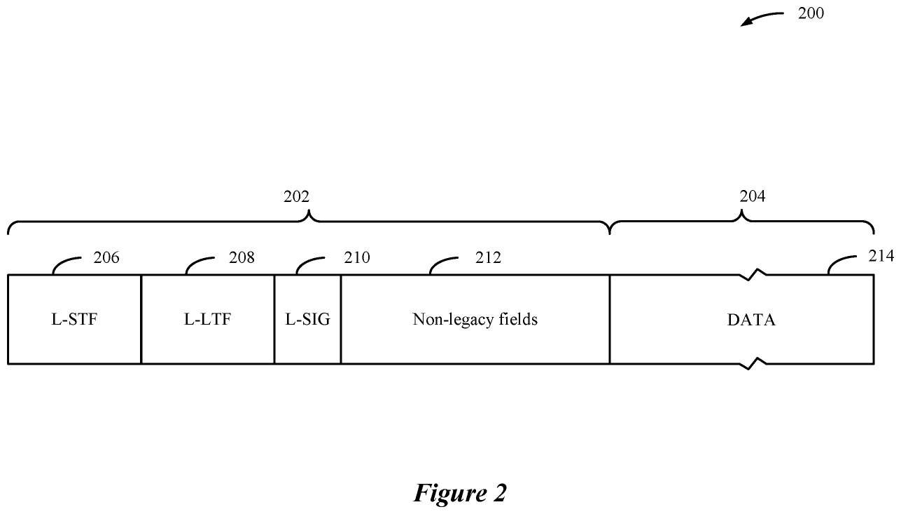

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

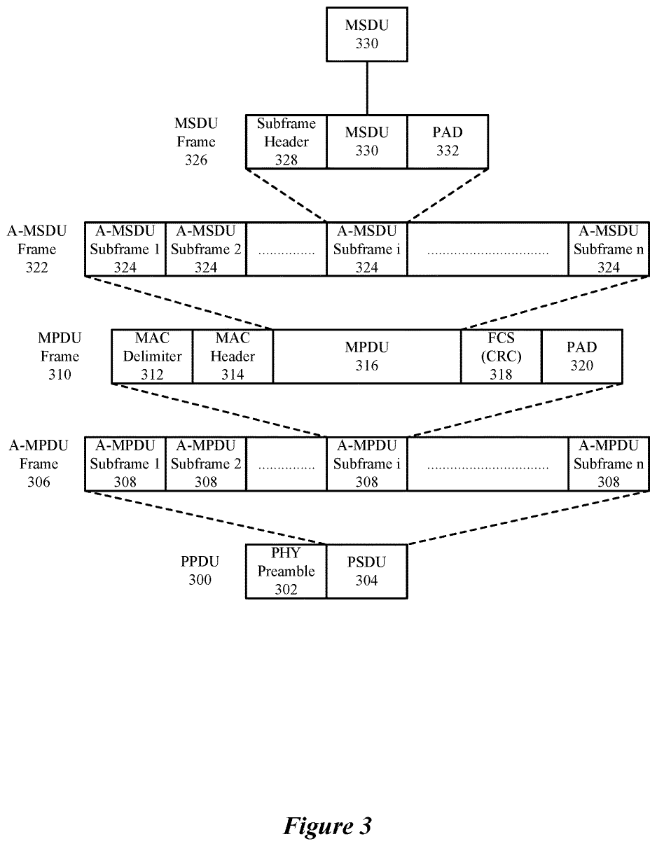

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Overview of Initial Control Frame (ICF)/Initial Control Response (ICR) Exchange Use Cases

In certain wireless systems, an exchange of frames, referred to as an initial control frame (ICF) and an initial control response (ICR) may be used for various purposes. For example, an ICF/ICR exchange may be performed to efficiently establish coordination between devices in preparation of a more complex transaction (e.g., involving data transmission, a measurement exchange, or the like).

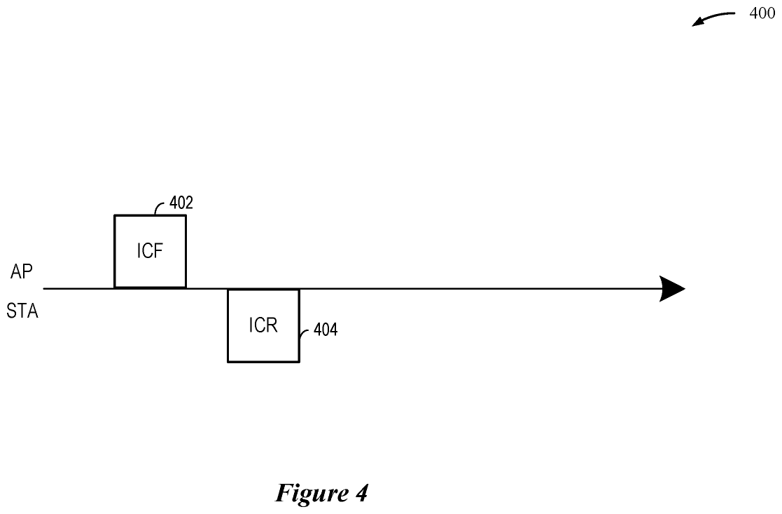

Diagram 400 of FIG. 4 illustrates an example ICF/ICR frame exchange between an AP and a STA. As shown, the AP transmits an ICF 410 to the STA. The STA responds with an ICR 420. The content of ICF 410 and ICR 420 may depend on a particular use case.

While the example in FIG. 4 shows an AP (an STA acting as an AP) transmitting the ICF 410 and a non-AP STA (a STA not acting as an AP) transmitting the ICR 420, for certain use cases, a STA may transmit an ICF and an AP may transmit an ICR in response to the ICF.

ICF/ICR exchanges may be used when a sensing-capable AP wants to schedule a channel impulse response (CIR) measurement with a (non-AP) STA. In such cases, the AP may send an ICF to the STA, indicating that it wants to initiate a sensing measurement. The STA responds with an ICR confirming readiness (or rejecting, or deferring) the request.

ICF/ICR exchanges may be used to establish multi-link operation (MLO), where one or more devices use multiple radio links simultaneously. Before sending full MLO frames, the devices may use an ICF/ICR exchange to synchronize capabilities or schedules.

ICF/ICR exchanges may be used for trigger-based Random Access Negotiation. In such cases, a STA that wants to perform a random access transmission may first check whether the AP is ready to accept it. The STA may send an ICF to the AP requesting permission or parameters for random access. The AP may respond with an ICR granting or modifying access parameters.

ICF/ICR exchanges may be used for channel access deferral notification, for example, where a STA tries to request channel access, but the AP knows that the channel will soon become busy. In such cases, the STA may send an ICF requesting access, while the AP may send back an ICR asking the STA to defer its access request.

ICR exchanges may also be used to set up a “light” beamforming procedure. For example, before performing a full sounding procedure (NDP +Feedback) for beamforming, the AP may check if the STA is beamforming-capable and ready. In such cases, an AP may send an ICF proposing to initiate beamforming. The STA may respond with an ICR indicating its current beamforming readiness or any restrictions.

As illustrated in FIG. 4, in some cases, feedback information may be carried in certain ICFs and/or ICRs. In the illustrated example, ICF 410 includes a feedback (FB) type field 412 and one or more feedback information fields 414. The feedback type field 412 may indicate a type of feedback included in the feedback information fields 414. Example feedback types may include dynamic unavailability operation (DUO) feedback, low latency indication (LLI) feedback, channel state information (CSI), signal-to-noise ratio (SNR) measurements, C-TDMA information, Co-BF information, or other feedback.

In some cases, an ICF may request feedback. In such cases, the ICF may specify resource allocations (e.g., time and frequency resources), timing requirements for responding, and/or whether the response should include compressed or uncompressed feedback data. In response to the ICF, the STA may transmit ICR that includes the requested feedback information and that may be formatted according to parameters indicated in the ICF. For example, if the feedback type field indicates CSI feedback, the ICR may contain a quantized or full-resolution CSI report. Alternatively, the feedback may include other measurements or status information, such as interference measurements, channel quality indicators (CQI), or timing advance information. The horizontal arrow represents the forward progression of time, with control signaling initiated by the AP and a corresponding response by the STA.

### Aspects Related to Feedback Absence Indication

Feedback information may be carried within certain ICF and ICR frames and/or other types of trigger frames (or frames). For example, a buffer status report poll (BSRP) trigger frame may carry DUO or other type feedback information.

The trigger frame may be, for example, a BSRP GI3 frame in which the guard interval (GI) and high-efficiency long training field (HE-LTF) type field has a value of 3. Such feedback signaling mechanisms may be designed to be sufficiently generic so as to accommodate other types of feedback as well, including, but not limited to, C-TDMA information for a polled AP, or Co-BF information.

Similarly, a multi-block acknowledgment (M-BA) frame may also carry feedback type and other feedback information. For example, the M-BA framework may be generic and extensible to support other types of feedback, such as C-TDMA information from one or more polled APs and/or Co-BF information.

As noted above, a feedback type field may be included to differentiate among the various types of feedback being carried. In one example, the feedback type field may be carried within a dedicated user information field of the trigger frame (TF), such as an ICF TF, where the user information field is identified by an AID12 value equal to a special value of AID (e.g., 2008). In another example, the feedback type field may be carried within a dedicated per AID traffic identifier (TID) information field of the M-BA frame, where the per AID TID information field is identified by an AID11 value equal to a special value (e.g., 2008) when addressed to all STAs, or by a specific STA AID if addressed to a single STA.

In some cases, there may be some uncertainty regarding how to handle situations where an ICF or ICR (or other frame that can carry feedback information) is ready for transmission but no feedback information is yet. Aspects of the present disclosure, however, provide various signaling mechanisms/techniques for indicating whether a frame carries feedback (and/or what type of feedback is carried in the frame).

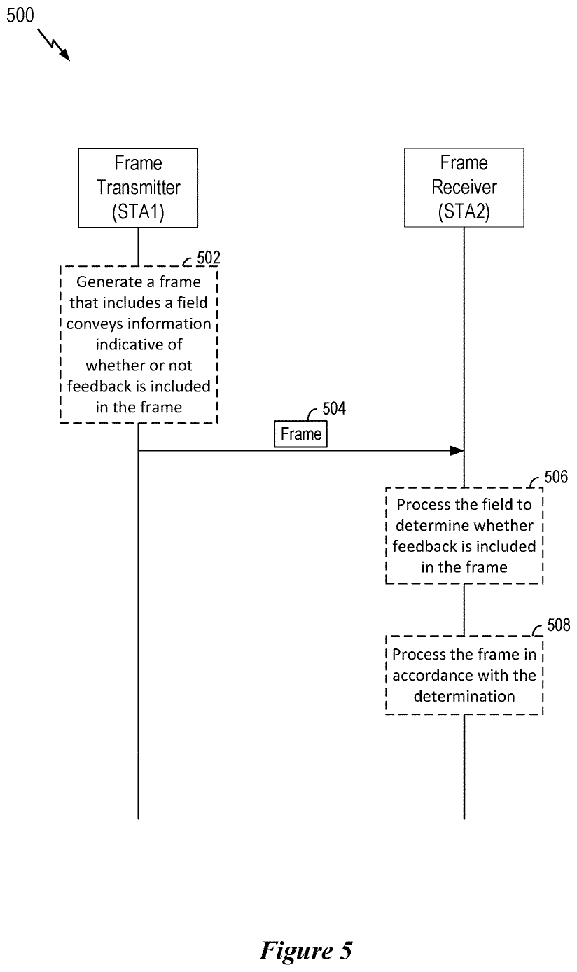

These techniques proposed herein may be understood with reference to example call flow diagram 500 FIG. 5. The example illustrates how a frame transmitter (an AP or non-AP STA1) may indicate the presence, absence and/or type of feedback carried in a frame transmitted to a frame receiver (an AP or non-AP STA2).

As illustrated at 502, STA1 generates a frame that includes a field that conveys information indicative of whether (or not) feedback is included in the frame. At 504, STA1 transmits the frame to STA2. For example, the frame may be an ICF or ICR and the indication may be conveyed via one or more specific values of a feedback type field.

As illustrated at 506, after receiving frame 504, STA 2 processes the field to determine whether feedback is included in the frame. As illustrated at 508, STA2 processes the frame in accordance with the determination. For example, if the feedback type field is set to a value that indicates the absence of feedback, the STA may terminate processing the rest of the frame. On the other hand, if the type field is set to a value that indicates the presence of feedback (of a certain type), the STA may process the rest of the frame to obtain the feedback (e.g., via a feedback information field).

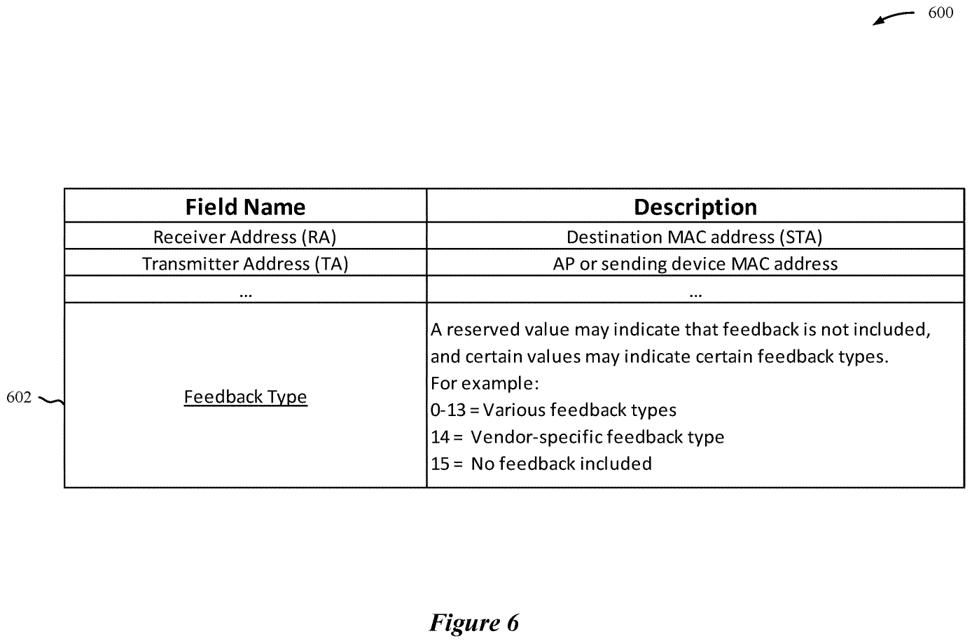

According to certain aspects of the present disclosure, a certain value of the feedback type field may be allocated to indicate that no feedback is reported/included. For example, as illustrated in the example table 600 of FIG. 6, a value of 15 (all ones assuming a 4-bit field) of the Feedback Type field 602 may indicate an absence of feedback (e.g., The Feedback User Information Field is absent or is present but is not carrying any feedback).

As illustrated in FIG. 6, other values may indicate certain feedback types. For example, assuming a 4-bit feedback type field, some values (e.g., 0-14) may indicate various feedback types. In the illustrated example, a value of 14 is used to indicate vendor-specific feedback type. Based on this value, a STA processing the frame may know that feedback in the feedback information may be vendor-specific and may act accordingly. For example, the STA may know the feedback only applies to services or features specific to the vendor, rather than globally. The vendor may be identified, for example, via a MAC address carried in the transmitter address (TA) of the frame.

By providing mechanisms for signaling whether a frame includes feedback, aspects of the present disclosure may help improve performance by allowing the frame to be generated before knowing whether it will include feedback. For example, other portions of the frame can be generated and a feedback type field may be updated (prior to transmission) once it is known whether or not the frame will include feedback.

This approach may reduce latency and allow the frame to be transmitted sooner. For example, a STA sending an ICF/ICR/CRF may not know until the last instance whether there is feedback to send. If there is feedback, the STA may populate the Feedback Information fields. If there is no feedback, then the Feedback Type field may be set to 15, and the rest of the Feedback information fields may be populated (e.g., with all ones or all zeroes). This may be similarly applied to A-Control, where Control ID=15 may be allocated for this purpose (e.g., referred to as ONES Control field, and all the contents are ones).

As noted above with reference to FIG. 6, a value of the Feedback Type field may be allocated to indicate vendor-specific feedback.

Vendors may decide how to populate the Feedback Information contents for a vendor-specific feedback type. In some cases, the vendor ID may be obtained (e.g., by a STA processing the feedback frame) from the MAC address that is carried in the transmitter address of the frame carrying the feedback (e.g., an ICF, ICR, or Coordinated Response Frame/CRF). The vendor ID may be expressed as a portion of the MAC address (e.g., the Organizationally Unique Identifier (OUI) portion).

In some cases, there may be multiple fields (e.g., Feedback User Information Fields in a Trigger frame, “Dedicated” Per AID TID Information Fields in M-BA frame) in a frame (e.g., an ICF/ICR) with the same Feedback Type. In such cases, a specific field can carry Vendor-Specific Feedback (and which field may depend on the type of frame). For example, for M-BA frames, the first Per AID TID field may carry the Feedback information for a Feedback Type (e.g., C-TDMA) specified by a wireless communications standard. The second Per AID TID field with the same Feedback Type may carry Vendor-Specific Feedback, such as Vendor-Specific C-TDMA information.

In some aspects, feedback information may be included in the first Per AID TID Information Field. This may be possible, for example, as the length of this field can be extended up to 128 octets. In such cases, the feedback information may be (e.g., or may need to be) ignored by certain devices (e.g., UHR STAs).

In some cases, rather than indicate vendor-specific feedback with a separate feedback type field, a defined pattern within the feedback information field itself may be used to indicate vendor-specific feedback.

For example, if the feedback information field that carries the feedback information for a feedback type starts/ends/contains a certain length (e.g., an octet long) of all ones or all zeroes, the Feedback information field is considered to carry vendor-specific feedback. In other words, the presence of a particular sequence of bits (e.g., all ones or all zeroes or some other reserved sequence, at the beginning) may indicate a vendor-specific feedback type. For example, for an M-BA frame, if the BA bitmap field of a per AID TID information field starts with an octet of all ones, the BA bitmap field is considered (e.g., indicated) to be carrying vendor-specific feedback. Similarly, for a TF, if the feedback user information field carries vendor-specific feedback, the first octet following the feedback type in the feedback user information field may be set to all ones or all zeroes. In some aspects, instead of an octet of all ones or zeroes, a special AID value (e.g., 2025) for the AID12 subfield of a feedback user information field in a TF and the AID11 subfield of a per AID TID information field in an M-BA frame may be used to indicate that vendor-specific feedback is being carried.

While certain examples described above refer to ICF and/or ICR frames as feedback carrying frames, the signaling mechanisms described herein may be applicable to any types of frames conveying feedback (e.g., any such type of trigger frame).

### Example Methods

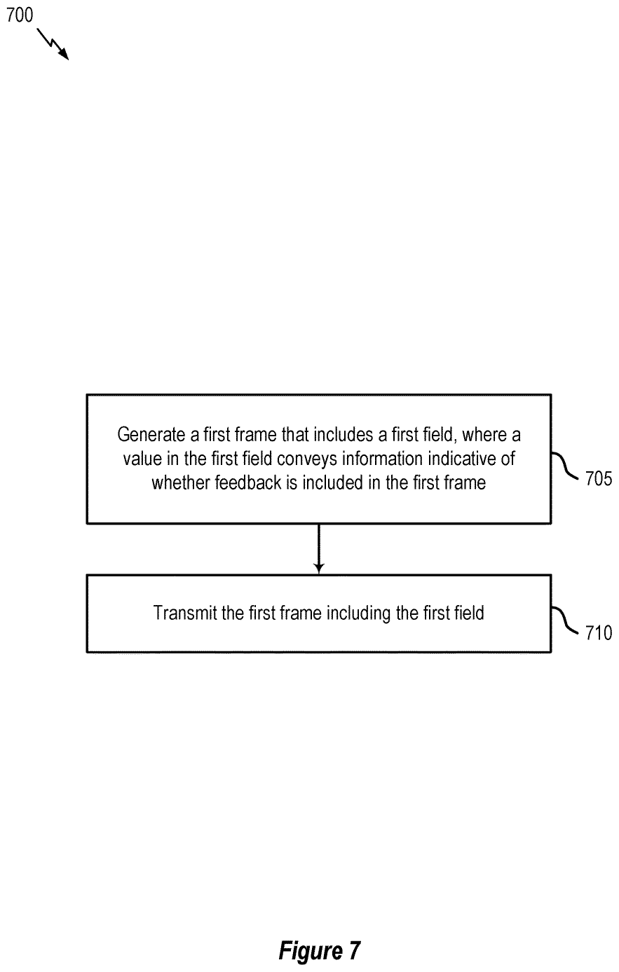

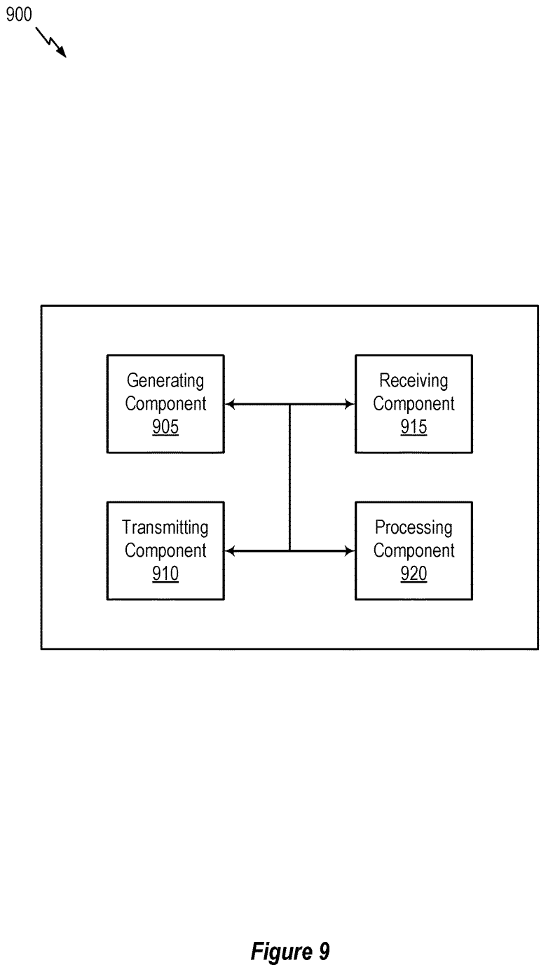

FIG. 7 shows a flowchart illustrating an example process 700 performable by or at a wireless node. The operations of the process 700 may be implemented by a wireless STA, or its components as described herein, and/or wireless AP, or its components as described herein. For example, the process 700 may be performed by a wireless communication device, such as the wireless communication device 900 described with reference to FIG. 9, operating as or within a wireless STA or operating as or within a wireless AP. In some examples, the process 700 may be performed by a wireless STA such as one of the STAs 104 described with reference to FIG. 1. In some examples, the process 700 may be performed by a wireless AP such as one of the APs 102 described with reference to FIG. 1.

In some examples, in block 705, the wireless node may generate a first frame that includes a first field, where a value in the first field conveys information indicative of whether feedback is included in the first frame. The operations at block 705 may be performed in a manner similar to that described elsewhere herein, such as at 502 of FIG. 5. In some cases, the operations of this step refer to, or may be performed by, a generating component as described with reference to FIG. 9.

In some examples, in block 710, the wireless node may transmit the first frame including the first field. The operations at block 710 may be performed in a manner similar to that described elsewhere herein, such as at 504 of FIG. 5. In some cases, the operations of this step refer to, or may be performed by, a transmitting component as described with reference to FIG. 9.

In some aspects, the first frame comprises at least one of: a trigger frame, an initial control frame (ICF), or an initial control response (ICR) frame, or a control response frame (CRF).

In some aspects, the first field comprises a feedback type field and the value in the first field is set to: a first value to indicate the first frame lacks feedback, or a second value to indicate a type of feedback is included in the first frame.

In some aspects, generating the first frame comprises: setting the value in the first field to the first value initially; and setting the value in the first field to the second value, after setting the value in the first field to the first value, if there is feedback to include in the first frame.

In some aspects, the second value indicates the type of feedback is vendor-specific feedback.

In some aspects, the first frame includes at least a second field that includes the vendor-specific feedback.

In some aspects, the first frame includes an indication of a vendor associated with the vendor-specific feedback.

In some aspects, the first frame includes multiple feedback fields associated with a same type of feedback, and the vendor-specific feedback is included in one of the multiple feedback fields.

In some aspects, which of the multiple feedback fields includes the vendor-specific feedback is based on a type of the first frame.

In some aspects, when the value in the first field is set to the second value, the first frame also includes a feedback information field, and one or more bits of the feedback information field indicate whether a type of feedback is vendor-specific feedback.

Note that FIG. 7 is just one example of a process, and other processes including fewer, additional, or alternative steps are possible consistent with this disclosure.

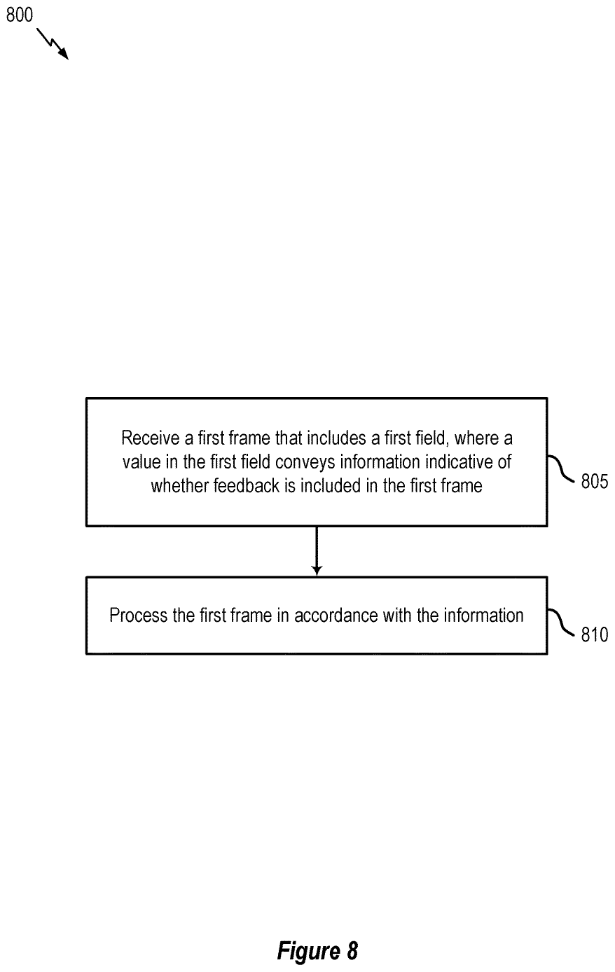

FIG. 8 shows a flowchart illustrating an example process 800 performable by or at a wireless node. The operations of the process 800 may be implemented by a wireless STA, or its components as described herein, and/or wireless AP, or its components as described herein. For example, the process 800 may be performed by a wireless communication device, such as the wireless communication device 900 described with reference to FIG. 9, operating as or within a wireless STA or operating as or within a wireless AP. In some examples, the process 800 may be performed by a wireless STA such as one of the STAs 104 described with reference to FIG. 1. In some examples, the process 800 may be performed by a wireless AP such as one of the APs 102 described with reference to FIG. 1.

In some examples, in block 805, the wireless node may receive (obtain) a first frame that includes a first field, where a value in the first field conveys information indicative of whether feedback is included in the first frame. The operations at block 805 may be performed in a manner similar to that described elsewhere herein, such as at 504 of FIG. 5. In some cases, the operations of this step refer to, or may be performed by, an receiving component as described with reference to FIG. 9.

In some examples, in block 810, the wireless node may process the first frame in accordance with the information. The operations at block 705 may be performed in a manner similar to that described elsewhere herein, such as at 506 and/or 508 of FIG. 5. In some cases, the operations of this step refer to, or may be performed by, a processing component as described with reference to FIG. 9.

In some aspects, processing the first frame comprises: discarding the first frame if the value in the first field indicates an absence of feedback in the first frame; or processing the first frame to obtain feedback if the value in the first field indicates that feedback is included in the first frame.

In some aspects, the first frame comprises at least one of: a trigger frame, an initial control frame (ICF), or an initial control response (ICR) frame, or a control response frame (CRF).

In some aspects, the first field comprises a feedback type field and the value in the first field is set to: a first value to indicate the first frame lacks feedback, or a second value to indicate a type of feedback is included in the first frame.

In some aspects, the second value indicates the type of feedback is vendor-specific feedback.

In some aspects, the first frame includes at least a second field that includes the vendor-specific feedback.

In some aspects, the first frame includes an indication of a vendor associated with the vendor-specific feedback.

In some aspects, the first frame includes multiple feedback fields associated with a same type of feedback, the vendor-specific feedback is included in one of the multiple feedback fields, and which of the multiple feedback fields includes the vendor-specific feedback is based on a type of the first frame.

In some aspects, when the value in the first field is set to the second value, the first frame also includes a feedback information field, and one or more bits of the feedback information field indicate whether a type of feedback is vendor-specific feedback.

Note that FIG. 8 is just one example of a process, and other processes including fewer, additional, or alternative steps are possible consistent with this disclosure.

### Example Device

FIG. 9 shows a block diagram of an example wireless communication device 900. In some examples, the wireless communication device 900 is configured to perform the process 700 described with reference to FIG. 7. In some examples, the wireless communication device 900 is configured to perform the process 800 described with reference to FIG. 8. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 900 may transmit the information output from the chip. In such an example, the second interface may refer to an interface between the processing system of the chip and a reception component, such that the device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. In some examples, the wireless communication device 900 can be configurable or configured for use in an AP, such as the AP 102 described with reference to FIG. 1. In some other examples, the wireless communication device 900 can be an AP that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system. In some examples, the wireless communication device 900 further includes at least one external network interface coupled with the processing system that enables communication with a core network or backhaul network that enables the wireless communication device 900 to gain access to external networks including the Internet.

The wireless communication device 900 includes generating component 905, transmitting component 910, receiving component 915, and processing component 920. Portions of one or more of the components 905, 910, 915, and 920 may be implemented at least in part in hardware or firmware. For example one or more of the components 905, 910, 915, and 920 may be implemented at least in part by a processor or a modem. In some examples, portions of one or more of the components 905, 910, 915, and 920 may be implemented at least in part by a processor and software in the form of processor-executable code stored in a memory.

### Example Clauses

Implementation examples are described in the following numbered clauses.
Clause 1: A method for wireless communication at a wireless node, including: generating a first frame that includes a first field, where a value in the first field conveys information indicative of whether feedback is included in the first frame; and transmitting the first frame including the first field.
Clause 2: The method of Clause 1, where the first frame includes at least one of: a trigger frame, an initial control frame (ICF), or an initial control response (ICR) frame, or a control response frame (CRF).
Clause 3: The method of any one of Clauses 1-2, where the first field includes a feedback type field and the value in the first field is set to: a first value to indicate the first frame lacks feedback, or a second value to indicate a type of feedback is included in the first frame.
Clause 4: The method of Clause 3, where generating the first frame includes: setting the value in the first field to the first value initially; and setting the value in the first field to the second value, after setting the value in the first field to the first value, if there is feedback to include in the first frame.
Clause 5: The method of Clause 3, where the second value indicates the type of feedback is vendor-specific feedback.
Clause 6: The method of Clause 5, where the first frame includes at least a second field that includes the vendor-specific feedback.
Clause 7: The method of Clause 5, where the first frame includes an indication of a vendor associated with the vendor-specific feedback.
Clause 8: The method of Clause 5, where the first frame includes multiple feedback fields associated with a same type of feedback, and the vendor-specific feedback is included in one of the multiple feedback fields.
Clause 9: The method of Clause 8, where which of the multiple feedback fields includes the vendor-specific feedback is based on a type of the first frame.
Clause 10: The method of Clause 3, where when the value in the first field is set to the second value, the first frame also includes a feedback information field, and one or more bits of the feedback information field indicate whether a type of feedback is vendor-specific feedback.
Clause 11: A method for wireless communication at a wireless node, including: receiving a first frame that includes a first field, where a value in the first field conveys information indicative of whether feedback is included in the first frame; and processing the first frame in accordance with the information.
Clause 12: The method of Clause 11, where processing the first frame includes: discarding the first frame if the value in the first field indicates an absence of feedback in the first frame; or processing the first frame to obtain feedback if the value in the first field indicates that feedback is included in the first frame.
Clause 13: The method of any one of Clauses 11-12, where the first frame includes at least one of: a trigger frame, an initial control frame (ICF), or an initial control response (ICR) frame, or a control response frame (CRF).
Clause 14: The method of any one of Clauses 11-13, where the first field includes a feedback type field and the value in the first field is set to: a first value to indicate the first frame lacks feedback, or a second value to indicate a type of feedback is included in the first frame.
Clause 15: The method of Clause 14, where the second value indicates the type of feedback is vendor-specific feedback.
Clause 16: The method of Clause 15, where the first frame includes at least a second field that includes the vendor-specific feedback.
Clause 17: The method of Clause 15, where the first frame includes an indication of a vendor associated with the vendor-specific feedback.
Clause 18: The method of Clause 15, where the first frame includes multiple feedback fields associated with a same type of feedback, the vendor-specific feedback is included in one of the multiple feedback fields, and which of the multiple feedback fields includes the vendor-specific feedback is based on a type of the first frame.
Clause 19: The method of Clause 14, where when the value in the first field is set to the second value, the first frame also includes a feedback information field, and one or more bits of the feedback information field indicate whether a type of feedback is vendor-specific feedback.
Clause 20: An apparatus, including: at least one memory including executable instructions; and at least one processor configured to execute the executable instructions and cause the apparatus to perform a method in accordance with any combination of Clauses 1-19.
Clause 21: An apparatus, including means for performing a method in accordance with any combination of Clauses 1-19.
Clause 22: A non-transitory computer-readable medium including executable instructions that, when executed by at least one processor of an apparatus, cause the apparatus to perform a method in accordance with any combination of Clauses 1-19.
Clause 23: A computer program product embodied on a computer-readable storage medium including code for performing a method in accordance with any combination of Clauses 1-19.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
generate a first frame that includes a first field, where a value in the first field conveys information indicative of whether feedback is included in the first frame; and
transmit the first frame including the first field.

2. The apparatus of claim 1, wherein the first frame comprises at least one of: a trigger frame, an initial control frame (ICF), or an initial control response (ICR) frame, or a control response frame (CRF).

3. The apparatus of claim 1, wherein the first field comprises a feedback type field and the value in the first field is set to: a first value to indicate the first frame lacks feedback, or a second value to indicate a type of feedback is included in the first frame.

4. The apparatus of claim 3, wherein generating the first frame comprises: setting the value in the first field to the first value initially; and setting the value in the first field to the second value, after setting the value in the first field to the first value, if there is feedback to include in the first frame.

5. The apparatus of claim 3, wherein the second value indicates the type of feedback is vendor-specific feedback.

6. The apparatus of claim 5, wherein the first frame includes at least a second field that includes the vendor-specific feedback.

7. The apparatus of claim 5, wherein the first frame includes an indication of a vendor associated with the vendor-specific feedback.

8. The apparatus of claim 5, wherein the first frame includes multiple feedback fields associated with a same type of feedback, and the vendor-specific feedback is included in one of the multiple feedback fields.

9. The apparatus of claim 8, wherein which of the multiple feedback fields includes the vendor-specific feedback is based on a type of the first frame.

10. The apparatus of claim 3, wherein when the value in the first field is set to the second value, the first frame also includes a feedback information field, and one or more bits of the feedback information field indicate whether a type of feedback is vendor-specific feedback.

11. An apparatus for wireless communication, comprising:
at least one memory comprising computer-executable instructions; and
one or more processors configured to execute the computer-executable instructions and cause the apparatus to:
receive a first frame that includes a first field, where a value in the first field conveys information indicative of whether feedback is included in the first frame; and
process the first frame in accordance with the information.

12. The apparatus of claim 11, wherein processing the first frame comprises:
discarding the first frame if the value in the first field indicates an absence of feedback in the first frame; or processing the first frame to obtain feedback if the value in the first field indicates that feedback is included in the first frame.

13. The apparatus of claim 11, wherein the first frame comprises at least one of: a trigger frame, an initial control frame (ICF), or an initial control response (ICR) frame, or a control response frame (CRF).

14. The apparatus of claim 11, wherein the first field comprises a feedback type field and the value in the first field is set to: a first value to indicate the first frame lacks feedback, or a second value to indicate a type of feedback is included in the first frame.

15. The apparatus of claim 14, wherein the second value indicates the type of feedback is vendor-specific feedback.

16. The apparatus of claim 15, wherein the first frame includes at least a second field that includes the vendor-specific feedback.

17. The apparatus of claim 15, wherein first frame includes an indication of a vendor associated with the vendor-specific feedback.

18. The apparatus of claim 15, wherein the first frame includes multiple feedback fields associated with a same type of feedback, the vendor-specific feedback is included in one of the multiple feedback fields, and which of the multiple feedback fields includes the vendor-specific feedback is based on a type of the first frame.

19. The apparatus of claim 14, wherein when the value in the first field is set to the second value, the first frame also includes a feedback information field, and one or more bits of the feedback information field indicate whether a type of feedback is vendor-specific feedback.

20. A method for wireless communication at a wireless node, comprising:
generating a first frame that includes a first field, where a value in the first field conveys information indicative of whether feedback is included in the first frame; and
transmitting the first frame including the first field.
